(19) United States
(12) Patent Application Publication
(10) Pub. No.: US 2024/0173963 A1
(43) Pub. Date: May 30, 2024

(54) METHOD FOR CONTROLLING A PRINTHEAD

(71) Applicant: ABB Schweiz AG, Baden (CH)

(72) Inventors: Andreas Skaar, Bryne (NO); Yngve Finnestad, Sandnes (NO); Elias Sundvoll, Ræge (NO)

(21) Appl. No.: 18/577,465

(22) PCT Filed: Jul. 15, 2021
(86) PCT No.: PCT/EP2021/069760

§ 371 Date: Jan. 8, 2024

(51) Int. Cl. B41J 2/045

(52) U.S. Cl. CPC B41J 2/04526; B41J 2/04505; B41J 2/04586

(57) ABSTRACT

A method of printing an image onto a surface using a printhead carried by a robot arm, including: obtaining an image which exceeds the predetermined print width of the printhead; splitting the image into at least two image strips, each contained within a reduced print width which is less than the predetermined print width, and generating associated printhead paths; detecting a deviation from the printhead paths when the robot arm is fed with a first control signal in a dry run; modifying the image strips to compensate the detected deviation by applying a local lateral shift; and printing the modified image strips onto the surface while the robot arm is fed with a control signal that is equivalent to the first control signal.

### TECHNICAL FIELD

The present disclosure relates to the field of robotic control applied to automated painting, and in particular to a method for printing an image onto a surface using a robot-carried printhead.

### BACKGROUND

Pixel printing is the dispensing of one or more paint colors onto selected areas of a plane or curved surface, to produce an image. Images which are wider than the printhead are produced by printing multiple parallel image strips, which are generated under an assumption that the printhead follows corresponding reference paths over the surface. In an optimal execution, the actual path of the printhead follows the reference path. Due to wear, mechanical inaccuracies, suboptimal position sensors or incomplete controllability of the printhead's motion, however, path deviations from the reference path have to be expected. In unfortunate cases, they will produce alignment errors in the printed image, such as visible gaps or overlaps.

DE102010004496 discloses a robot with a print head and a method for controlling print head matrices and correcting trajectory deviations. A three-dimensional path deviation between a desired path of the printhead and an actual path is detected during productive operation, by means of an integrated path-detecting sensor. If a deviation is found, the printhead matrix is controlled as a function of this deviation.

### SUMMARY

One objective of the present disclosure is to propose method and devices by which deviations from the intended printhead path can be compensated. It is particularly interesting to provide such compensation when the printhead is carried by a robot arm. A further objective is to compensate path deviations without a need to replace existing robot equipment or modify the equipment permanently.

At least some of these objectives are achieved by the invention as defined by the independent claims. The dependent claims relate to advantageous embodiments of the invention.

In a first aspect of the invention, there is provided a method of printing an image onto a surface using a printhead carried by a robot arm. The image may be monochrome or comprise multiple colors. The method is directed to the case where an image which exceeds the predetermined print width w of the printhead is to be printed. If the image can be printed by a single pass of the printhead, deviations from the reference printhead path will displace the printed image but generally do not produce visible defects of the type discussed above. In a next step, the image is split into at least two image strips, each contained within a reduced print width wo which is less than the predetermined print width, and associated printhead paths are generated. In response to detecting a deviation from the printhead paths when the robot arm is fed with a first control signal, the image strips are modified to compensate the detected deviation by applying a local lateral shift. Preferably, while the deviation is detected during a dry run, the first control signal is equivalent to a future control signal that is to be used during productive operation, i.e., printing runs.

Conceptually, the image strips may be understood as pixel patterns in a local reference frame centered at a point on the printhead, where, for each longitudinal position y, pixels are active only in an area whose width is the reduced print width wo. The inactive pixels, which occupy a total width of w−w₀, also form part of image strips. Before any lateral shift has been applied, the inactive pixels may represent two edges that have equal widths w_{L}=w_{R}=(w−w₀)/2. The lateral shift does not alter the values of the active pixels but moves them to the left (or the right), as needed. To carry out a lateral shift of d units, the width w_{R} of the right (left) edge is increased and the width w_{L} of the left (right) edge is shrunk by this amount:

$${w}_{L} = \frac{w - {w}_{0}}{2} + d ,$$

$${w}_{R} = \frac{w - {w}_{0}}{2} - d .$$

The area with the active pixels fits within the print width w as long as 2|d|≤w−w₀. If the edges with inactive pixels are initiated with unequal widths w_{L}≠w_{R}, a larger shift in one of the directions may be tolerated, in extreme cases up to w−w₀.

Compared with the background art reviewed above, where path deviations are detected during productive operation, the first aspect of the present invention enables more efficient compensation of systematic (or non-aleatoric) errors, related to wear, mechanical inaccuracies, suboptimal position sensors or incomplete controllability of the printhead's motion. Systematic errors tend to repeat identically for every run, though possibly overlaid with process noise and aleatoric errors. Thus, it is advantageous to detect the systematic error component accurately in a preliminary run and derive a compensation (local lateral shift) that is fit to be applied in all productive runs. Indeed, an operator has a reasonable chance to discover whether the sensing of the printhead position is accurate during the preliminary run (and take appropriate action), but it would be a tedious task to monitor the accuracy throughout productive operation and check for failures and incidents. The preliminary run may be a dry run or a printing run.

Another advantage associated with the present invention is that accurate printhead positioning, which is useful during the preliminary run, is merely optional in productive operation. Accordingly, even a robot arm that lacks high-accuracy position sensors can be used with the present compensation method, namely, if the path deviation is sensed using a detachable highly accurate position sensor. Besides, a single detachable position sensor can be used with multiple robot arms, which limits capital investment. As used herein, a position sensor is “detachable” if those sensor components which must be arranged at the printhead during sensing—this may include active or passive components—can be separated nondestructively from the printhead after sensing has ended. Alternatively, contactless position sensing, such as by a camera system, can be used.

In a second aspect of the present invention, there is provided a controller adapted to control a printhead carried by a robot arm to print an image onto a surface. The controller comprises a first interface configured to accept image data and a position sensor signal, a second interface configured to output a printhead control signal, and processing circuitry configured to execute the above method.

The invention further relates to a computer program containing instructions for causing a computer, or the controller in particular, to carry out the above method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order described, unless explicitly stated.

### BRIEF DESCRIPTION OF THE DRAWINGS

Aspects and embodiments are now described, by way of example, with reference to the accompanying drawings, on which:

FIG. 1 is a flowchart of a method of printing an image onto a surface using a robot-carried printhead, according to an embodiment of the invention;

FIG. 2 shows a printing system comprising a robot arm equipped with a printhead and an associated controller, according to an embodiment of the invention;

FIG. 3 shows the active side of two example printheads;

FIGS. 4A and 4B illustrate the splitting of an image into straight image strips with associated printhead paths;

FIG. 4C illustrates a detected deviation from a printhead path;

FIG. 4D shows contours of a modified image strip adapted to compensate the deviation in FIG. 4C; and

FIG. 5 illustrates a case of non-rectilinear splitting of an image into image strips with associated printhead paths.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

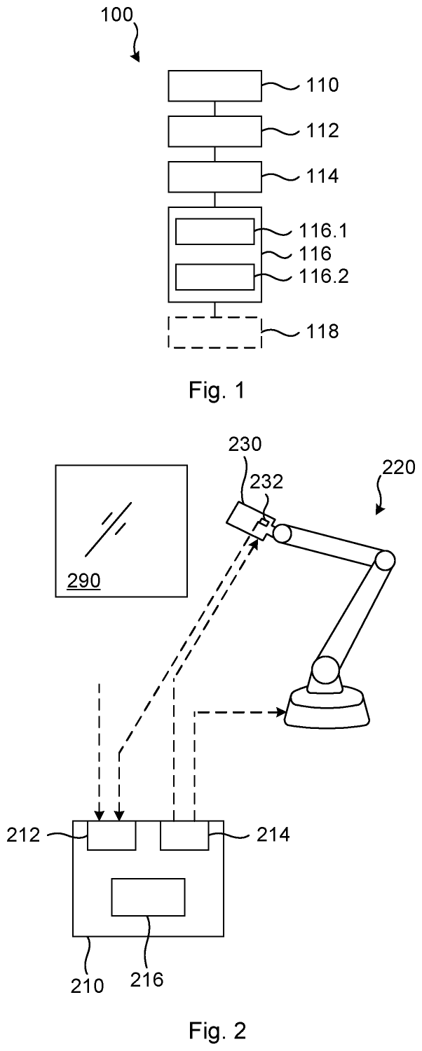

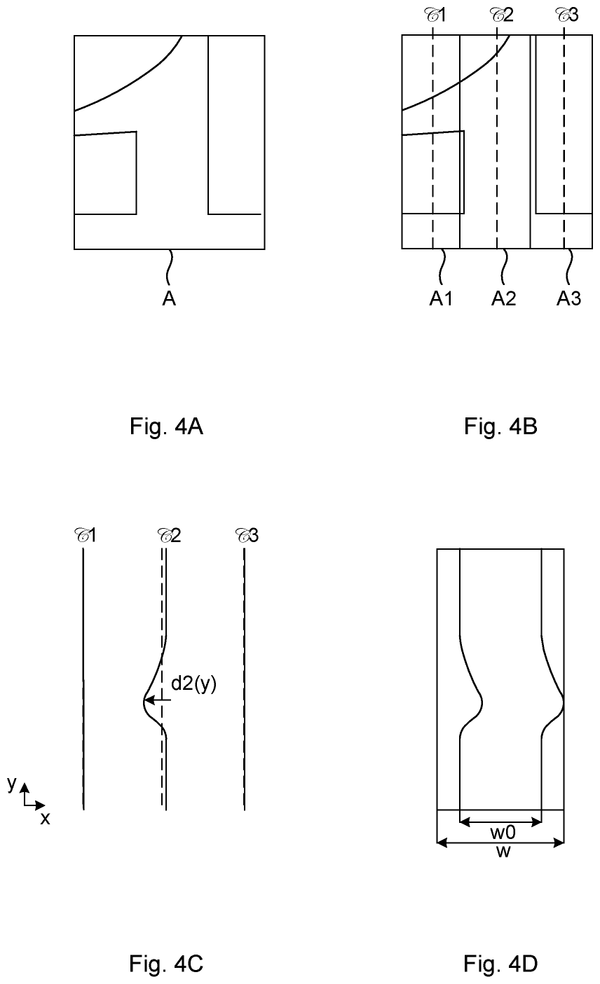

FIG. 1 is a flowchart of a method 100 of printing an image onto a surface using a robot-carried printhead. An example image A representing the character “1” is shown in FIG. 4A. An example surface 290 and printhead 230 are shown in FIG. 2.

FIG. 2 further shows a robot arm 220, which comprises multiple members and linear/rotary joints and is equipped with an end effector in the form of a printhead 230. The movements of the robot arm 220 has finite accuracy, i.e., when a control signal orders the robot arm 220 to assume a certain position or pose, then this is fulfilled only within a tolerance. A position-oriented tolerance may be expressed as a maximum tolerated error of the position of a tool-center point (TCP). A typical value of the position-oriented tolerance in an industrial painting robot may be 0.5 mm. A pose-oriented tolerance may be expressed as a maximum tolerated linear/angular error of the robot arm's 220 joints. Additionally or alternatively, the tolerance may express the maximum tolerated error of the robot arm's 220 self-reported pose or position. The tolerance according to any of these options may be specified by a commercial provider of the robot arm 220 or it may be computed at the user side based on position measurements at an accuracy superior to the robot's tolerance.

A controller 210 for controlling the printhead 230 is provided. In the embodiment shown in FIG. 2, the controller 210 is multifunctional in the sense that it acts as well as a robot controller for controlling actuators (not shown) in the robot arm 220. In other embodiments, the controller 210 may be implemented as a dedicated printhead controller, a separate entity adapted to operate in parallel with a robot controller.

The example controller 210 in FIG. 2 has a first interface 212 configured to accept image data and a position sensor signal generated by a position sensor 232 associated with the printhead. The design, type and measuring principle of the position sensor 232 are not essential to the present invention. For example, the position sensor 232 may an optical position sensor, a laser-equipped position sensor or a camera system including one or more cameras. It is appreciated that while FIG. 2 shows a position sensor 232 attached to the printhead 230, contactless position sensing according to the mentioned options may not require that any active sensing component be arranged at the printhead 230; it may not even be necessary to provide the printhead 230 with a visual marker, fiducial or the like. To the extent a positioning technique is used that requires an active or passive component of the position sensor 232 to be arranged (mounted) at the printhead 230, it is advantageous to use a detachable component. If the detachable component has been secured by a temporary adhesive or a releasable mechanical fastener during the detection phase, it may be removed nondestructively once the deviation detection has been completed. This way, the component is protected from contamination or mechanical damage during operation of the printhead 230. Besides, it is ensured that the surface 290 is unobscured and thereby easy to monitor and inspect.

The position sensor's 232 tolerance is preferably less than the robot arm's 220 tolerance. In some embodiments, the tolerance of the position sensor 232 is 0.1 mm or less. These embodiments may be suitable for printing images on surfaces that have a total extent of the order of 0.1 m, 1 m or 10 m. Moreover, a position sensor 232 with a tolerance of 0.1 mm or less is also meaningful to use with a robot arm 220 whose tolerance is 0.5 mm or more.

The controller 210 further comprises a second interface 214 which is configured to output a printhead control signal. In the multifunctional embodiment shown in FIG. 2, the second interface 214 is also configured to provide a control signal to the robot arm 220. Processing circuitry 216 in the controller 210 is configured to perform the method 100 to be described next. Alternatively, the controller 210 may accept the image data via an operator input/output interface (not shown) or a network interface (not shown).

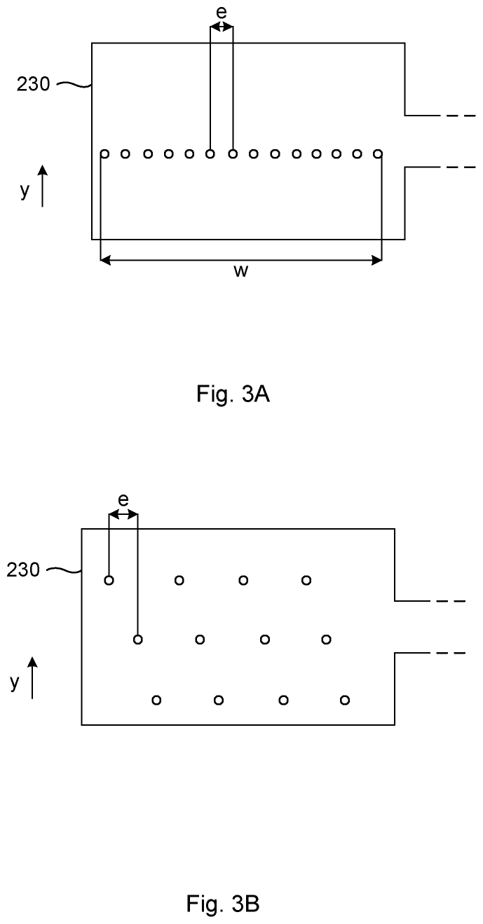

FIGS. 3A and 3B show example printheads 230 which are suitable for use in the present method 100. A connection towards the robot arm 220 is suggested at the right side of each figure. The illustrated printheads 230, which may each include an inkjet head or a spray gun, are adapted to move substantially in the longitudinal direction indicated by y (vertical on the drawing) during printing. The longitudinal direction will generally be aligned with a printhead path while the printhead 230 is active.

In FIGS. 3A and 3B, the hollow circles represent individually controllable pixels, which may correspond structurally to nozzles or other means for depositing on the surface 290 an ink, paint, dye or the like. It is appreciated that while the example pixel arrangements to be discussed herein may relate to a single color, more evolved printheads 230 may include multiple such pixel arrangements corresponding to respective colors. A linear pixel arrangement is shown in FIG. 3A, while FIG. 3B illustrates a matrix-shaped pixel arrangement. The horizontal extent w of the pixels corresponds to a print width of the printhead 230. As used in the present disclosure, a pitch of the printhead 230 is the pixel resolution in a direction transverse to the longitudinal direction (horizontal on the drawing). Accordingly, the pitch e of the linear pixel arrangement in FIG. 3A corresponds to the spacing of adjacent pixels. The pitch e of the matrix-like pixel arrangement in FIG. 3B corresponds to the transverse spacing. In some embodiments, to ensure effective compensation of a detected path deviation, the pitch e of the printhead 230 is less than the robot arm's 220 (position-oriented) tolerance.

Returning to FIG. 1, a first step 110 of the method 100 is to obtain an image A, e.g., in the form of a compressed or uncompressed image format and/or as bitmap or vector graphics. It is assumed in this description that the image A exceeds the predetermined print width w of the printhead 230. The image A exceeds this width w unless it can be printed in one continuous run where no segment of the printed pattern is adjacent (or contiguous, or tangent) to another segment of the printed pattern; such adjacent segments can be subject to alignment errors if the robot arm has a nonnegligible position tolerance. For example, even if a solid circle with a diameter greater than w could theoretically be printed by moving the printhead 230 in a spiral path, it would be a challenging task to align consecutive turns with each other, and the option of splitting the circle into multiple image strips would be preferred; the solid circle wider than w may therefore be regarded as an image exceeding the print width w. By contrast, an image of arbitrary length which is nowhere wider than w does not exceed the print width w.

In a second step 112, to enable the printhead 230 to print the image A, the image A is split into at least two image strips which are each contained within a reduced print width w₀ and associated printhead paths are generated. The reduced print width w₀ is less than the print width w of the printhead 230. It is noted that the criterion as to whether splitting is needed refers to the print width w, but the width of the image strips is the reduced print width w₀ or less.

To illustrate the effects of this step 112, FIG. 4A shows an image A which exceeds the print width w, and FIG. 4B shows the same image A split into three image strips A₁, A₂, A₃ (delimited by solid vertical lines). Each of the image strips A₁, A₂, A₃ is less than w₀ units wide and is associated with a printhead path [symbol] ₁, [symbol] 2, [symbol] ₃ (shown as dashed vertical lines). A printhead path [symbol] ₖ corresponds to the movement of the printhead 230. More precisely, printhead path [symbol] ₖ may be understood as the trajectory traced by the projection on the surface 290 of a reference point on the printhead 230. The reference point may for instance be the center of the printhead's 230 pixel arrangement. In relation to the image strip Aₖ, the printhead path [symbol] ₖ may be an approximate centerline.

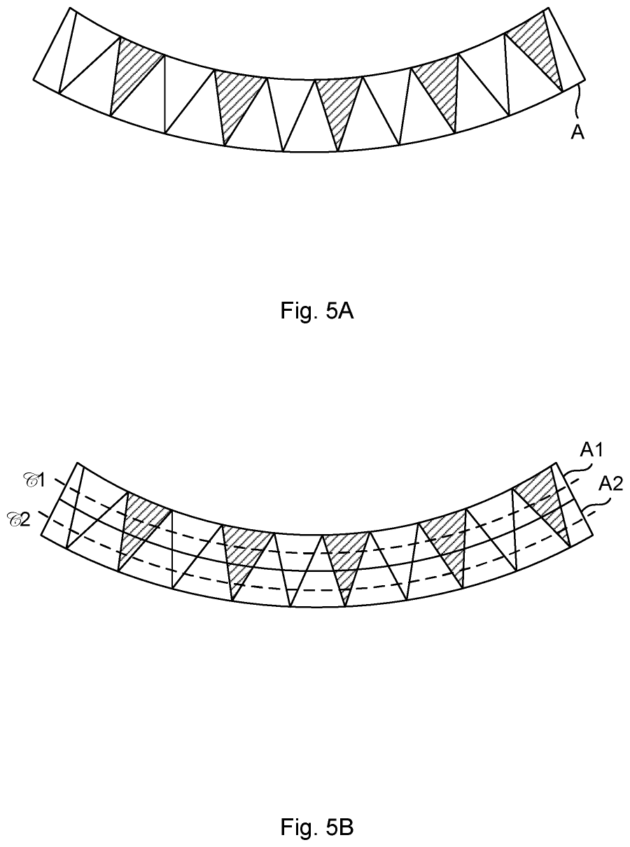

FIG. 5 illustrates a case of non-rectilinear (curved) splitting of the image A in FIG. 5A into two image strips A₁, A₂ with associated printhead paths [symbol] ₁, [symbol] ₂, as seen in FIG. 5B. The image strips A₁, A₂ have non-straight boundaries but, on the other hand, a geometry which is relatively regular with respect to the longitudinal component, thereby allowing the printhead 230 to be utilized fully over the entire length of each image strip A₁, A₂. The non-rectilinear splitting is advantageous in the case shown in FIG. 5 due to the elongated and curved shape of the obtained image A; an imaginable rectilinear splitting of the image A would have produced smaller and more numerous straight image strips, with awkward non-orthogonal or slanted end portions where only a portion of the printhead 230 were utilized.

In a third step 114 of the method 100, a deviation from the printhead paths [symbol] ₁, [symbol] ₂, [symbol] ₃ is detected while the robot arm is fed with a first control signal. The first control signal may order the robot arm 220 to move the printhead 230 along the paths [symbol] ₁, [symbol] ₂, [symbol] ₃. The third step 114 may be performed during a dry run but could also be performed during a printing run, including productive operation. FIG. 4C illustrates a possible outcome of the third step 114, wherein the first and third printhead paths [symbol] ₁, [symbol] ₃ are followed with only a negligible deviation. For the second printhead path [symbol] ₂, however, a deviation is detected. The deviation is not constant over the length of the path [symbol] ₂. It may be represented as signed difference function d₂(y) between the printhead path [symbol] ₂ and the actual trajectory of the printhead 230, wherein the difference d₂(y) is measured in the transverse direction x for each longitudinal coordinate y.

The detection of the deviation is straightforward for a plane surface 290. If the surface 290 is curved, the deviation at a point of the surface 290 may detected in the tangent plane at that point. In the tangent plane, the deviation detection is additionally restricted to the transverse direction, i.e., the deviation shall be orthogonal to the printhead path.

In a fourth step 116, the image strips are modified to compensate the detected deviation by applying a local lateral shift. In the running example, the first and third image strips A₁, A₃ are not in need of modification since no deviation from the first and third printhead paths [symbol] ₁, [symbol] ₃ was detected. For the second image strip A₂, however, it is suitable to apply a local lateral shift, variable over the length of the path [symbol] ₂, which cancels the deviation. An aim of the compensation is to make the pixel pattern of the second image strip A₂ end up at or near its intended location on the surface 290. The local lateral shift may for example be the negative of the difference function, −d₂(y). FIG. 4D shows the right and left contours of the area with active pixels in the second image strip A₂ after such a shift has been applied.

In further developments of the fourth step 116, a deviation from one printhead path [symbol] ₖ can be compensated more efficiently and/or less intrusively by not only modifying 116.1 the associated image strip Aₖ but also modifying 116.2 one or both adjacent image strips A_{k±1}. This may for example enable compensation of relatively large deviations. As FIG. 4D illustrates, the lateral shift of −d₂(y) will cause the area with active pixels to nearly touch the right-hand boundary of the image strip A₂, which is at the feasible limit of the printhead 230. In the notation introduced above, the width of the right edge

$${w}_{R} ( y ) = \frac{w - {w}_{0}}{2} - {d}_{2} ( y )$$

will locally be close to zero. In the mentioned developments of the fourth step 116, therefore, the compensation of a deviation is distributed across several image strips, by shifting the first image strip A₁ by a constant D; shifting the second image strip A₂ by D−d₂(y) units; and shifting the third image strip A₃ by D units. By choosing D such that

$$0 < D < {max}_{y} {d}_{2} ( y ) ,$$

such joint shifting of the image strips can ensure that w_{R}>0 for all y, though at the price of displacing the printed image A on the surface 290 by D units.

In still other embodiments of the fourth step 116, the detected deviations for all the printhead paths [symbol] ₁, [symbol] ₂, [symbol] ₃ are considered jointly. For example, the compensations can be found by solving a system of equations. Separate systems of equations can be formulated and solved for different longitudinal segments of the printhead paths [symbol] ₁, [symbol] ₂, [symbol] ₃, wherein a smoothness condition (patching condition) between consecutive segments may be applied. Alternatively or additionally, the modified image strips are obtained by solving an optimization problem using an objective function which takes into account the detected deviations and which penalizes large local lateral shifts and/or poor alignment of image strips.

In an optional further step 118 of the method 100, the modified image strips are printed onto the surface 290 while the robot arm 220 is fed with a control signal that is equivalent to the first control signal. Step 118 may be performed in productive operation. Since it is reasonable to assume that the systematic (non-aleatoric) component of the printhead's 230 deviation from the printhead paths [symbol] ₁, [symbol] ₂, [symbol] ₃ will repeat in a near-identical fashion, an efficient and near-complete compensation can be expected.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. A method of printing an image onto a surface using a printhead carried by a robot arm, the method comprising:
obtaining an image which exceeds a predetermined print width of the printhead;
splitting the image into at least two image strips, each contained within a reduced print width which is less than the predetermined print width, and generating associated printhead paths;
detecting a deviation from the printhead paths when the robot arm is fed with a first control signal; and
modifying the image strips to compensate the detected deviation by applying a local lateral shift.

2. The method of claim 1, further comprising:
printing the modified image strips onto the surface while the robot arm is fed with a control signal that is equivalent to the first control signal.

3. The method of claim 1, wherein the deviation is detected during a dry run.

4. The method of claim 1, wherein the deviation is detected during a printing run.

5. The method of claim 1, wherein the deviation is detected (114) using a detachable position sensor.

6. The method of claim 1, wherein the deviation is detected using a position sensor having a tolerance which is less than the robot arm's tolerance.

7. The method of claim 1, wherein the deviation is detected (114) using a position sensor with a tolerance of 0.1 mm or less.

8. The method of claim 1, wherein the deviation is detected (114) using an optical or laser-equipped position sensor or a camera system.

9. The method of claim 1, wherein the printhead has a plurality of individually controllable pixels defining a pitch that is less than the robot arm's tolerance.

10. The method of claim 1, wherein said modifying includes:
modifying at least the image strip corresponding to a printhead path for which a deviation was detected; and
modifying at least one adjacent image strip.

11. The method of claim 1, wherein said modifying includes considering the detected deviations jointly.

12. The method of claim 1, wherein said modifying includes applying a lateral shift equal to at most the difference of the print width and the reduced print width.

13. The method of claim 1, wherein the printhead includes an inkjet head and/or a spray gun.

14. A controller adapted to control a printhead carried by a robot arm to print an image onto a surface, the controller comprising:
a first interface configured to accept image data and a position sensor signal;
a second interface configured to output a printhead control signal; and
processing circuitry configured to execute the method including the steps of:
obtaining an image which exceeds a predetermined print width of the printhead;
splitting the image into at least two image strips, each contained within a reduced print width which is less than the predetermined print width, and generating associated printhead paths;
detecting a deviation from the printhead paths when the robot arm is fed with a first control signal; and
modifying the image strips to compensate the detected deviation by applying a local lateral shift.

15. A computer program comprising instructions to cause a controller adapted to control a printhead carried by a robot arm to print an image onto a surface the instructions executing a method comprising:
a first interface (212) configured to accept image data and a position sensor signal;
a second interface (214) configured to output a printhead control signal; and
processing circuitry (216) configured to execute the method of any of the preceding claims obtaining an image which exceeds a predetermined print width of the printhead;
splitting the images into at least two image strips, each contained within a reduced print width which is less than the predetermined print width, and generating associated printhead paths;
detecting a deviation from the printhead paths when the robot arm is fed with a first control signal; and
modifying the image strips to compensate the detected deviation by applying a local lateral shift.

16. The method of claim 2, wherein the deviation is detected during a dry run.

17. The method of claim 2, wherein the deviation is detected during a printing run.

18. The method of claim 2, wherein the deviation is detected (114) using a detachable position sensor.

19. The method of claim 2, wherein the deviation is detected using a position sensor having a tolerance which is less than the robot arm's tolerance.

20. The method of claim 2, wherein the deviation is detected (114) using a position sensor with a tolerance of 0.1 mm or less.
